(19) United States
(12) Patent Application Publication
(10) Pub. No.: US 2012/0032853 A1
(43) Pub. Date: Feb. 9, 2012

(54) Direction Finding Antenna

(75) Inventor: Jouni Vesa Juhani Karkinen, Oulu (FI)

(73) Assignee: Nokia Corporation

(21) Appl. No.: 12/851,601

(22) Filed: Aug. 6, 2010

(51) Int. Cl. G01S 5/04; H01Q 21/00

(52) U.S. Cl. 342/445; 343/893

(57) ABSTRACT

An apparatus for a direction finding system is described. The apparatus includes at least three antenna elements. Each antenna element faces in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction. The back plate is disposed in a second plane parallel to the first plane and the second plane is behind the first plane. The apparatus may be used to receive at least one signal from a transmitter. A distance and a direction from the apparatus to the transmitter may be determined based at least in part on the received at least one signal. Methods and computer readable media are also described.

### TECHNICAL FIELD

The exemplary and non-limiting embodiments of this invention relate generally to wireless communication systems, methods, devices and computer programs and, more specifically, relate to antennas suitable for direction finding systems.

### BACKGROUND

This section is intended to provide a background or context to the invention that is recited in the claims. The description herein may include concepts that could be pursued, but are not necessarily ones that have been previously conceived or pursued.

The following abbreviations that may be found in the specification and/or the drawing figures are defined as follows:
3GPP third generation partnership project
BW bandwidth
CDM code division multiplexing
DL downlink (eNB towards UE)
eNB E-UTRAN Node B (evolved Node B)
EPC evolved packet core
E-UTRAN evolved UTRAN (LTE)
HARQ hybrid automatic repeat request
LTE long term evolution of UTRAN (E-UTRAN)
MAC medium access control (layer 2, L2)
MM/MME mobility management/mobility management entity
Node B base station
O&M operations and maintenance
OFDMA orthogonal frequency division multiple access
PDCP packet data convergence protocol
PHY physical (layer 1, L1)
PIFA planar inverted F antenna
PWB printed wiring board
RLC radio link control
RRC radio resource control
RRM radio resource management
SC-FDMA single carrier, frequency division multiple access
S-GW serving gateway
UE user equipment, such as a mobile station or mobile terminal
UL uplink (UE towards eNB)
UTRAN universal terrestrial radio access network
XPD cross-polarization discrimination

Direction finding systems may be used to determine the direction and distance to a transmitter. This information is estimated by utilizing phase and amplitude information. However, direction finding antennas need to be specifically designed to fulfill the system requirements. Traditional antennas, for example, monopoles and PIFA, may not meet the system requirements causing the performance of the array to be insufficient for the direction finding system.

Antennas such as monopoles and PIFAs may utilize the ground plane for radiation. Thus, the radiation properties of the antenna (for example, radiation pattern, polarization properties, isolation between antennas operating at the same frequency band) are heavily influenced by the ground plane radiation.

In a direction finding system, antenna arrays (and the individual antenna which comprise the array) need to meet the requirements for the system. One such parameter is the horizontal polarization which is used for estimating the direction and distance of a transmitter. Single antennas and antenna arrays should have a sufficient cross-polarization discrimination (for some purposes, the vertical component may be ignored/minimized). For traditional antennas, this may be a problem due to a large range of variation between the horizontal/vertical plane gains.

The radiation pattern of an antenna may be influenced by a circuit board connected to the antenna, as the circuit board may contain at least a part of the ground plane. The antenna gain or radiation pattern may vary in different directions. In direction finding systems it may be preferred to use an antenna with a smooth radiation pattern for at least one sector, for example, in the sector of the antenna. A deep notch in the radiation pattern may mean performance degradation in performance for direction finding.

When several similarly tuned antennas operate at similar frequencies, antenna isolation may be an issue. The ground plane radiation may prevent the antennas from radiating efficiently enough for direction finding systems. The isolation may be up to 5-6 dB with traditional monopole antennas which are located close to each other.

Typically, at least three specific direction finding antennas may be used. These antennas may occupy a good amount of printed wiring board (PWB) space. The space used may also be taken up by the additional use of baluns to connect the antennas. Based on the application, this space may be in short supply.

What is needed is a new antenna such that provides sufficient XPD for direction finding systems when considered individually or in an array with at least one additional antenna. The antenna should also have a smooth radiation pattern for at least one sector, provide reasonable antenna isolation and use minimal PWB space.

### SUMMARY

The below summary section is intended to be merely exemplary and non-limiting. The foregoing and other problems are overcome, and other advantages are realized, by the use of the exemplary embodiments of this invention.

In a first aspect thereof an exemplary embodiment of this invention provides an apparatus for a direction finding system. The apparatus includes at least three antenna elements. Each antenna element is facing in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction and the back plate is disposed in a second plane parallel to the first plane and where the second plane is behind the first plane.

In a further aspect thereof an exemplary embodiment of this invention provides a method for direction finding. The method includes receiving at least one signal from a transmitter which is received by an antenna array. The antenna array includes at least three antenna elements, each antenna element facing in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction and the back plate is disposed in a second plane parallel to the first plane and where the second plane is behind the first plane. The method also includes determining a distance and a direction from the array to the transmitter based at least in part on the received at least one signal.

In an additional aspect thereof an exemplary embodiment of this invention provides a computer readable medium. The computer readable medium is tangibly encoded with a computer program executable by a processor to perform actions for direction finding. The actions include receiving at least one signal from a transmitter which is received by an antenna array. The antenna array includes at least three antenna elements, each antenna element facing in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction and the back plate is disposed in a second plane parallel to the first plane and where the second plane is behind the first plane. The actions also include determining a distance and a direction from the array to the transmitter based at least in part on the received at least one signal.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows a simplified block diagram of exemplary electronic devices that are suitable for use in practicing various exemplary embodiments of this invention.

FIG. 2 shows a more particularized block diagram of an exemplary user equipment such as that shown at FIG. 1.

FIG. 3 shows a simplified block diagram of a first exemplary embodiment in accordance with this invention.

FIG. 4 shows a simplified block diagram of a second exemplary embodiment in accordance with this invention.

FIG. 5 illustrates an exemplary antenna in accordance with this invention.

FIG. 6 is a logic flow diagram that illustrates the operation of an exemplary method, and a result of execution of computer program instructions embodied on a computer readable memory, in accordance with various exemplary embodiments of this invention.

FIG. 7 displays antenna gain graphs for various exemplary embodiments of this invention.

FIG. 8 displays antenna array gain graphs for various exemplary embodiments of this invention.

### DETAILED DESCRIPTION

Conventional antennas (for example, monopoles, PIFAs etc.) may use a large amount of PWB space in order to implement a direction finding antenna array. Various exemplary embodiments in accordance with this invention can be added to the mechanical features, for example, carriers or frames, can be used to carry or support antenna elements, thus, moving the antenna elements away from the circuit board so as to save space on the surface of the circuit board. Such exemplary antennas may be built without using expensive, high εᵣ (dielectric constant) ceramics or other high relative permittivity materials.

Additionally, exemplary antenna arrays (using the exemplary antennas) may fulfill various direction finding parameters (for example, smooth radiation pattern, polarization properties, etc.). Isolation may also be improved. It is also possible to eliminate the use of baluns, for example, as used to connect conventional antennas.

Various exemplary embodiments in accordance with this invention include an antenna array comprising of three antennas, designed for a direction finding system. The antenna elements may comprise a feeding branch, a parasitic branch, a back plate and an antenna frame or carrier. The antenna frame or carrier may act as a mechanical support structure for the antenna structure. The antenna structure may be a kind of loop structure where flow of current horizontally is maximized and by keeping vertical component of antenna as low as possible and the vertical component of electric field is minimized. A back plate or reflector of the antenna may be implemented behind the horizontal “arms” on the other side of the carrier. The horizontal back plate may load the horizontal antenna “arms” and creates at least one resonance. The length of both (feeding/parasitic) “arms” and the size of back plate may also be used in antenna tuning.

An exemplary antenna structure in accordance with this invention may be integrated into the mechanics of an apparatus (for example, a mobile telephone) in order to save space from on the PWB. For example, the antenna structure may be integrated on the inside surface of an external cover of the apparatus, molded into the wall thickness of an external cover of the apparatus or the antenna structure may form at least a part of the external cover of the apparatus and may be seen and touched by a user of the apparatus.

An exemplary antenna structure in accordance with this invention may give a smooth response in the horizontal plane towards the sector where the antenna is pointing. An exemplary single antenna in accordance with this invention may provide a 10 dB cross polarization ratio while an exemplary antenna array in accordance with this invention may provide a cross polarization ratio of more than 8 dB. Isolation between similarly tuned antennas may be around 10-15 dB. Such an antenna array may also provide good array ambiguity for a sector of interest.

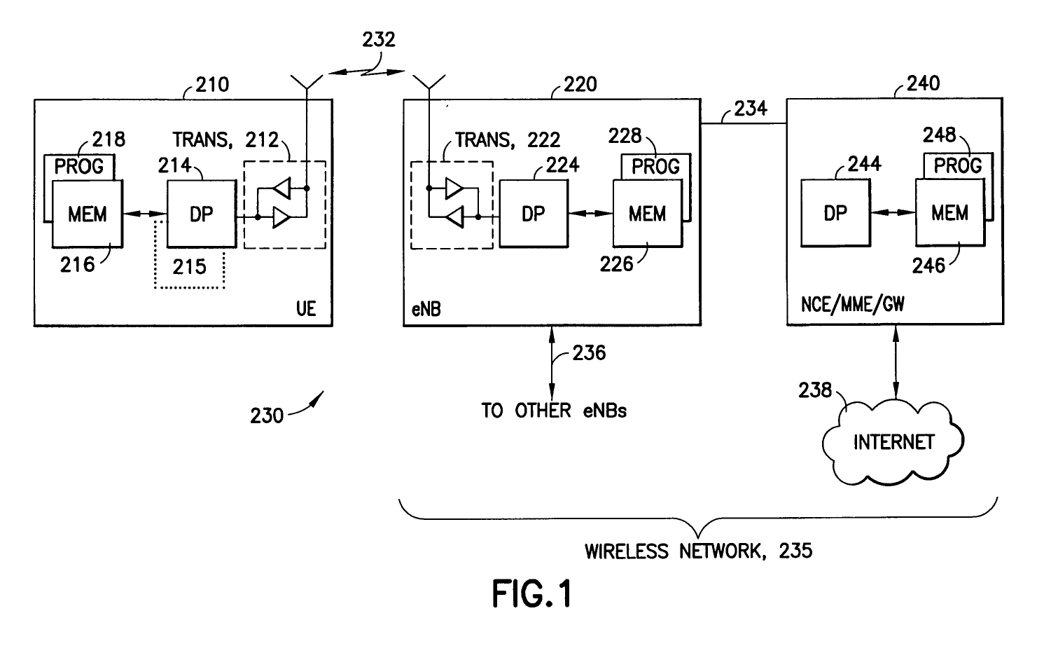

Before describing in further detail various exemplary embodiments of this invention, reference is made to FIG. 1 for illustrating a simplified block diagram of various electronic devices and apparatus that are suitable for use in practicing exemplary embodiments of this invention.

In the wireless system 230 of FIG. 1, a wireless network 235 is adapted for communication over a wireless link 232 with an apparatus, such as a mobile communication device which may be referred to as a UE 210, via a network access node, such as a Node B (base station), and more specifically an eNB 220. The network 235 may include a network control element (NCE) 240 that may include MME/SGW functionality, and which provides connectivity with a network, such as a telephone network and/or a data communications network (for example, the internet 238).

The UE 210 includes a controller, such as a computer or a data processor (DP) 214, a computer-readable memory medium embodied as a memory (MEM) 216 that stores a program of computer instructions (PROG) 218, and a suitable wireless interface, such as radio frequency (RF) transceiver 212, for bidirectional wireless communications with the eNB 220 via one or more antennas.

The eNB 220 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the UE 210 via one or more antennas. The eNB 220 is coupled via a data/control path 234 to the NCE 240. The path 234 may be implemented as an S1 interface. The eNB 220 may also be coupled to another eNB via data/control path 236, which may be implemented as an X2 interface.

The NCE 240 includes a controller, such as a computer or a data processor (DP) 244, a computer-readable memory medium embodied as a memory (MEM) 246 that stores a program of computer instructions (PROG) 248.

At least one of the PROGs 218, 228 and 248 is assumed to include program instructions that, when executed by the associated DP, enable the device to operate in accordance with exemplary embodiments of this invention, as will be discussed below in greater detail.

That is, various exemplary embodiments of this invention may be implemented at least in part by computer software executable by the DP 214 of the UE 210; by the DP 224 of the eNB 220; and/or by the DP 244 of the NCE 240, or by hardware, or by a combination of software and hardware (and firmware).

The UE 210 may also include dedicated processors, for example direction finding processor 215.

In general, the various embodiments of the UE 210 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 216, 226 and 246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 and 244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (for example, RF transceivers 212 and 222) may be of any type suitable to the local technical environment and may be implemented using any suitable communication technology such as individual transmitters, receivers, transceivers or a combination of such components.

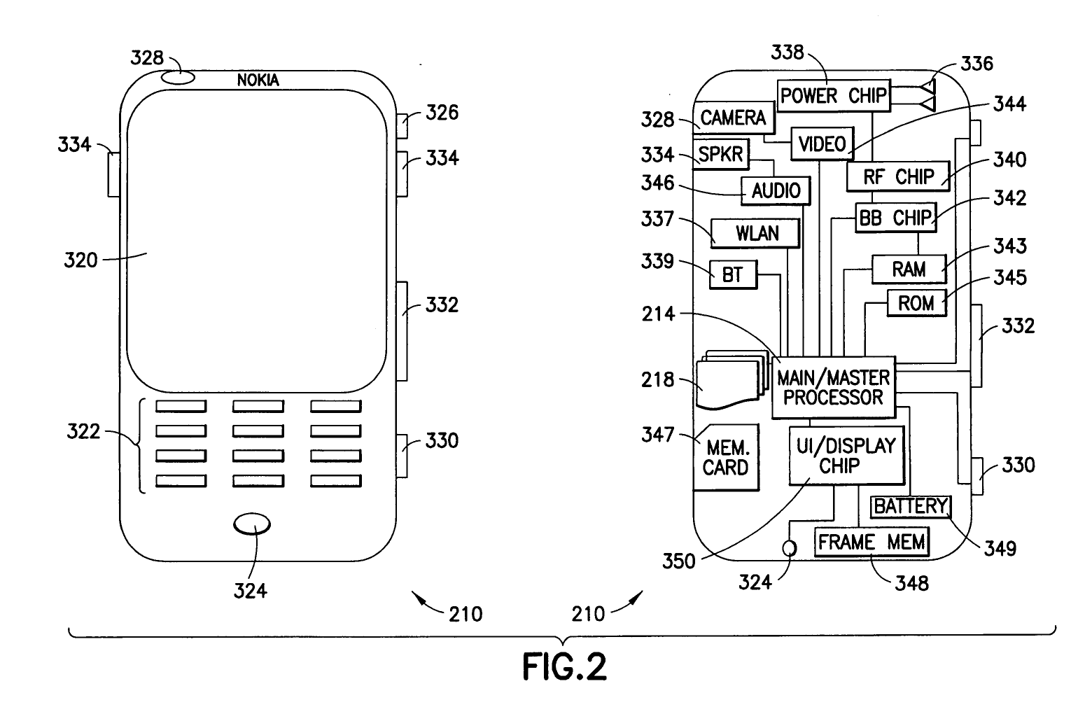

FIG. 2 illustrates further detail of an exemplary UE in both plan view (left) and sectional view (right), and the invention may be embodied in one or some combination of those more function-specific components. At FIG. 2 the UE 210 has a graphical display interface 320 and a user interface 322 illustrated as a keypad but understood as also encompassing touch-screen technology at the graphical display interface 320 and voice-recognition technology received at the microphone 324. A power actuator 326 controls the device being turned on and off by the user. The exemplary UE 210 may have a camera or image capturing device 328 which is shown as being forward facing (for example, for video calls) but may alternatively or additionally be rearward facing (for example, for capturing images and video for local storage). The camera 328 is controlled by a shutter actuator 330 and optionally by a zoom actuator 332 which may alternatively function as a volume adjustment for the speaker(s) 334 when the camera 328 is not in an active mode.

Within the sectional view of FIG. 2 are seen multiple transmit/receive antennas 336 that are typically used for cellular communication. The antennas 336 may be multi-band for use with other radios in the UE. The operable ground plane for the antennas 336 is shown by shading as spanning the entire space enclosed by the UE housing though in some embodiments the ground plane may be limited to a smaller area, such as disposed on a printed wiring board on which the power chip 338 is formed. The power chip 338 controls power amplification on the channels being transmitted and/or across the antennas that transmit simultaneously where spatial diversity is used, and amplifies the received signals. The power chip 338 outputs the amplified received signal to the radio-frequency (RF) chip 340 which demodulates and downconverts the signal for baseband processing. The baseband (BB) chip 342 detects the signal which is then converted to a bit-stream and finally decoded. Similar processing occurs in reverse for signals generated in the apparatus 210 and transmitted from it.

Signals to and from the camera 328 pass through an image/video processor 344 which encodes and decodes the various image frames. A separate audio processor 346 may also be present controlling signals to and from the speakers 334 and the microphone 324. The graphical display interface 320 is refreshed from a frame memory 348 as controlled by a user interface chip 350 which may process signals to and from the display interface 320 and/or additionally process user inputs from the keypad 322 and elsewhere.

Certain embodiments of the UE 210 may also include one or more secondary radios such as a wireless local area network radio WLAN 337 and a Bluetooth® radio 339, which may incorporate an antenna on-chip or be coupled to an off-chip antenna. Throughout the apparatus are various memories such as random access memory RAM 343, read only memory ROM 345, and in some embodiments removable memory such as the illustrated memory card 347. The various programs 218 are stored in one or more of these memories. All of these components within the UE 210 are normally powered by a portable power supply such as a battery 349.

Processors 338, 340, 342, 344, 346, 350, if embodied as separate entities in a UE 210 or eNB 220, may operate in a slave relationship to the main processor 214, 224, which may then be in a master relationship to them. Embodiments of this invention are most relevant to the multiple transmit/receive antennas 336, the wireless local area network radio WLAN 337 and the Bluetooth® radio 339, though it is noted that other embodiments need not be disposed there but may be disposed across various chips and memories as shown or disposed within another processor that combines some of the functions described above for FIG. 2. Any or all of these various processors of FIG. 2 access one or more of the various memories, which may be on-chip with the processor or separate therefrom. Similar function-specific components that are directed toward communications over a network broader than a piconet (for example, components 336, 338, 340, 342-345 and 347) may also be disposed in exemplary embodiments of the access node 220, which may have an array of tower-mounted antennas rather than the two shown at FIG. 2.

Note that the various chips (for example, 338, 340, 342, etc.) that were described above may be combined into a fewer number than described and, in a most compact case, may all be embodied physically within a single chip.

Various exemplary embodiments in accordance with this invention include antennas for use in direction finding systems. Such systems may operate at one or more frequency bands, for example, at 2.4 GHz ISM frequency band. Such a direction finding system may also use Location Enhancement Ultra Low Power Bluetooth antennas.

The direction finding system may use at least three direction finding antennas that form an antenna array. These antennas may be connected to the receiver through an electrical switch. For example, non-reflective switches may be used to connect three direction finding antennas to a receiver one by one. Antennas may be terminated with a given impedance, which, for example, may be approximately 50Ω resistive, when not in use.

Various exemplary embodiments in accordance with this invention include antennas which can be integrated to the mechanics of a device (for example, a frame within the apparatus or the external cover or housing of the apparatus) saving space on the PWB. Additionally, if ceramic based PWB mounted antennas were used they may be susceptible to cracking due to the mechanical stresses and forces placed on such a surface mounted antenna on the PWB and this may be eliminated by using alternative antenna structures or types other than PWB mounted ceramic antennas.

Various exemplary embodiments in accordance with this invention include antennas made without use of any special materials in the carrier. Conventional PWB mounted antennas (for example, chip antennas and more specifically ceramic chip antennas which may be monopoles, dipoles, loops, PIFAs, IFAs, and not limited to this list of antenna types) may be built using ceramics having a high relative dielectric constant, or relative permittivity (εᵣ), for example, an εᵣ=21. However, an exemplary antenna in accordance with this invention may be built or manufactured without the use of special materials, for example, a material having an εᵣ=3 in the carrier. This simplifies the manufacturing and may save costs. Such a material may be a plastic, for example, polycarbonate PC-ABS or other suitable low loss and low dielectric material which are suitable for radio frequency antennas. Antennas usually require a low loss material in the close vicinity of the antenna element so as to minimize any RF losses by absorption of RF energy into the material. Such materials are measured by the loss tangent, or tan δ, and a loss tangent of less than 0.001 may be considered as low loss at specific operational frequencies whereas at other frequencies this may be considered to be too high.

An exemplary antenna in accordance with this invention may have an integratable antenna structure which satisfies various parameters. A first parameter is that the antenna has a good and smooth radiation response (for example, horizontal polarization) in the horizontal plane towards the sector that the antenna is pointing. Similarly, an exemplary antenna array in accordance with this invention may give a smooth radiation response in all directions of interest (for example, a front sector of 90° to 270°), having a variation less than 8 dB (for example, 2 to 3 dB). Another parameter may be that the exemplary antenna has about a 10 dB cross polarization ratio. An exemplary antenna array may have a cross polarization ratio which is greater than 6 dB (for example, approximately 8 dB). A further parameter may be that the exemplary antenna array has an array ambiguity of less than 0.65. Another parameter may be that the exemplary antenna array has an antenna isolation between similarly tuned antennas to be around 10 to 15 dB. Using conventional monopole antennas, the antenna isolation may be limited to at most 5 to 6 dB.

An exemplary antenna in accordance with this invention may consist of four parts: 1) a feeding branch, 2) a parasitic branch, 3) a back plate and 4) an antenna frame or carrier.

An exemplary antennas structure may be a loop structure where horizontal current flow is maximized while the vertical component of the antenna is kept as low as possible, minimizing the vertical component of the electric field.

The antenna back plate, or reflector, may be implemented behind the horizontal arms, on the other side of the carrier. The horizontal back plate, which may be connected to ground, loads the horizontal antenna “arms” and creates at least one resonance. The back plate may be used to tune the antenna for some frequency bands, for example, around 2.45 GHz, or the back plate may be eliminated for other frequency bands.

An exemplary antenna may be tuned by adjusting the lengths of both the feeding arm and the parasitic arm, and by adjusting the slot between the branches. The size and shape of the back plate may also be adjusted to tune the antenna in two or even three dimensions. A series inductor, for example having 1.3 nH, may be used to electrically extend the parasitic arm and help in tuning the antenna.

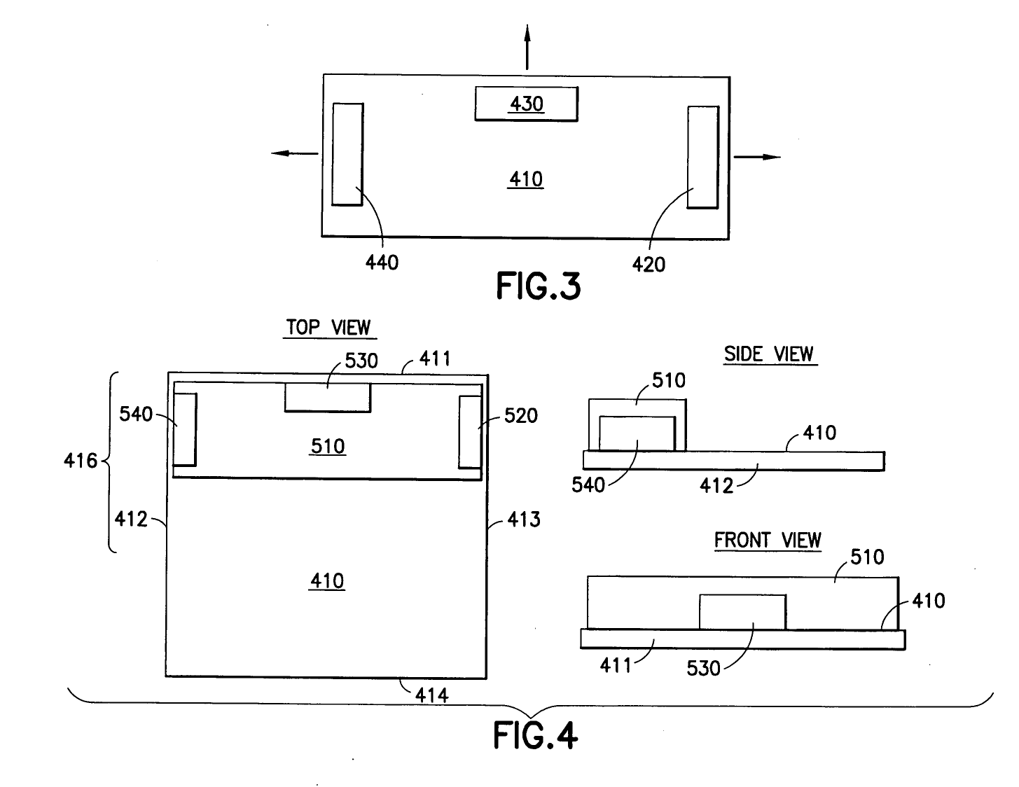

FIG. 3 shows a simplified block diagram of a first exemplary embodiment in accordance with this invention. A circuit board 410, for example a PWB, is shown with three antenna elements, right antenna 420, top antenna 430 and left antenna 440. Circuit board 410 may be embodied within a UE 210 and may incorporate various components of the UE 210.

Antennas 420, 430 and 440 may be considered as a single antenna array. The individual antennas may each have a facing, for example, antenna 420 faces to the right, antenna 430 faces forward and antenna 440 faces to the left. This non-limit example of facings are illustrative only, various other facings may be used. For example, the antennas 420, 430, 440 may be curved such that a facing may be spread around the curve of the face of the antenna rather than the flat antenna structures which are illustrated in FIG. 3.

Antennas 420, 430 and 440 be of any type suitable to the local technical environment and may be implemented using various antenna technologies, for example, ceramic antennas. The antennas may be connected, for example, via switches, to various components of the UE 210, for example, to a direction finding processor 215.

In a direction finding system, signals received by the antennas may be analyzed, for example, by the direction finding processor 215, in order to determine the direction and distance to the transmitter. Direction and distance information may then be provided to a user via a display 320.

FIG. 4 shows a simplified block diagram of a second exemplary embodiment in accordance with this invention. Circuit board 410 is shown with antenna frame 510 in FIG. 4. The circuit board 410 comprises four edges, first, second, third and fourth edges 411, 412, 413, 414 of the circuit board 410. Circuit board 410 is shown with the antenna frame 510 attached at a first end 416 of the circuit board 410, where the first 411, second 412 and third 413 edges meet. Embodied in the antenna frame 510 are three antennas 520, 530 and 540. Antenna 520 faces outward from the third edge 413 at the first end 416 of the circuit board 410, antenna 530 faces outward from the first edge 411 of the first end 416 of the circuit board 410 and antenna 540 faces outward from the second edge 412 of the first end 416 of the circuit board 410. On the side view, antenna 540 is shown embodied on the side of antenna frame 510 near the second edge 412. Likewise, the forward view shows antenna 530 is shown embodied on the front of the antenna frame 510 near the first edge 411.

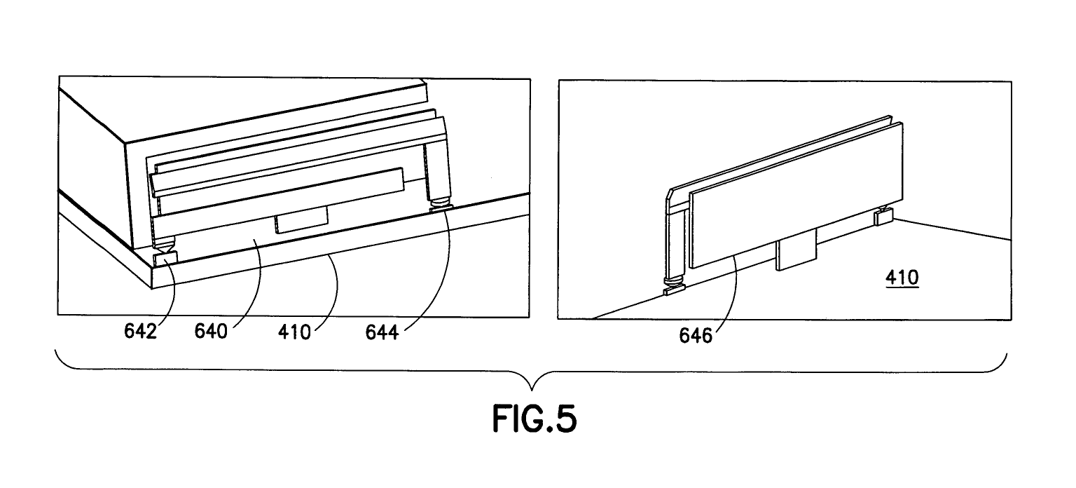

FIG. 5 illustrates an exemplary antenna in accordance with this invention. Antenna 640 is shown attached to circuit board 410. Antenna 640 comprises a feeding arm 642, a parasitic arm 644 and a back plate 646. As shown, feeding arm 642 is closer to the first edge 411 of the circuit board 410, thus, this is a top feeding antenna.

The antenna 640 has a facing direction perpendicular to the plane of the feeding arm 642 and parasitic arm 644 and the plane of the back plate. The plane of the back plate 644 is behind the plane of the feeding arm 642 and parasitic arm 644.

The feeding arm 642, parasitic arm 644 and back plate 646 are shown free standing for ease in viewing. These elements may be embodied within antenna frame 510 or another structure, for example, an external case, cover or housing of a mobile telephone or other portable electronic device.

In another embodiment, feeding arm 642 and parasitic arm 644 are flipped, such that the parasitic arm 644 is closer to the first edge 411 of the circuit board 410. This results in an antenna fed from the bottom.

An exemplary antenna in accordance with this invention may be embodied having a configuration where both side antennas 420, 440 are fed from the “top” direction or top corner where the first and second edges 411, 412 meet for the antenna 440, or where the first and third edges 411, 413 meet for the antenna 420. Another configuration may be where one side antenna 420 is fed from the “bottom” direction while the other side antenna 440 is fed from the “top” direction, for example, the right side antenna 420 may be fed from the “bottom” direction. In another exemplary embodiment, when both antennas are fed from the “top” direction, radiation patterns of both side antennas 420, 440 are nearly identical or mirrored.

An exemplary antenna element may be considered as a loop antenna structure that is loaded with the back plate. The loop antenna structure minimizes a vertical component of a corresponding electric field.

In an exemplary antenna in accordance with this invention, the central (or top) antenna may also be used as a Bluetooth/WLAN antenna when not being used as a direction finding antenna. Other radio protocols may also utilize one or more of the antenna elements 420, 430 and 440 when they are not being used as direction finding antennas in an array mode of operation, for example, the Bluetooth/WLAN example already mentioned above may not be limited to these protocols only, or limited to the following further examples. As further non-limiting examples, one or more antenna elements may be used for cellular frequency bands like EGSM, WCDMA, LTE, or GPS, or FM radio, or DVB-H, or as separate receive only and transmit only antennas within a single protocol, or as diversity antennas as used in MIMO antenna systems or LTE.

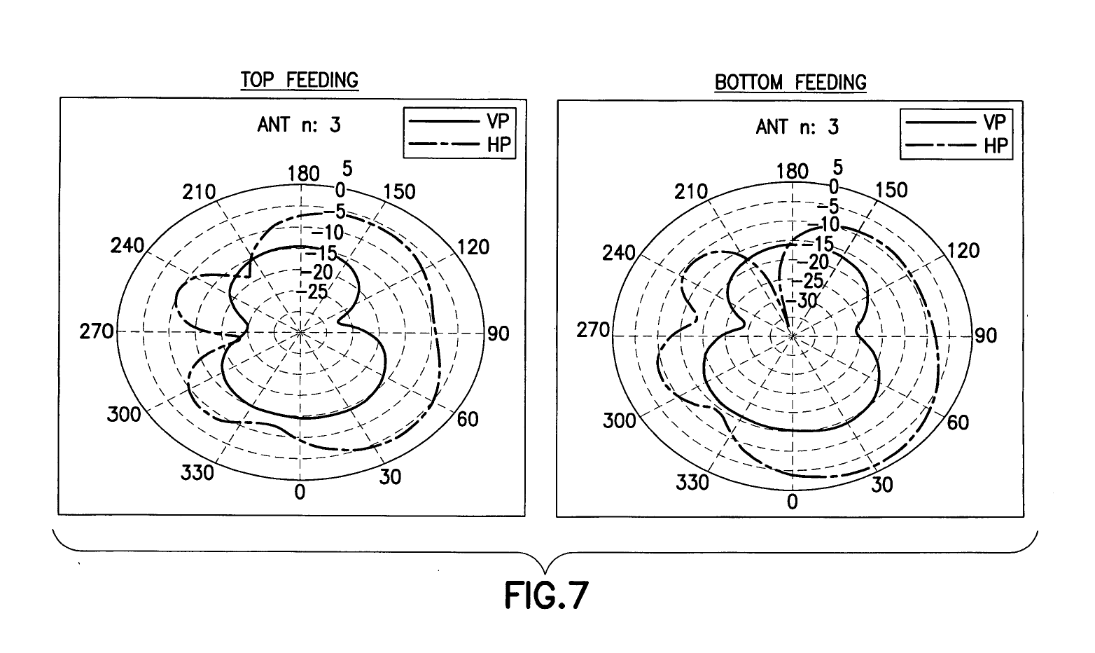

FIG. 7 displays antenna gain graphs for various exemplary embodiments of this invention. These graphs show the vertical polarization (VP) and horizontal polarization (HP) component antenna gains or 2D radiation patterns for a top feeding antenna and a bottom feeding antenna. Each antenna is located at the right edge of the corresponding PWB. The HP gain for a top feeding antenna has relatively smooth pattern in the right sector (from 0° to 180°). The HP gain for a bottom feeding antenna has relatively smooth pattern pointing to the bottom direction and has a deep null at the front sector (from 90° to 270°). In both configurations, the VP is minimized.

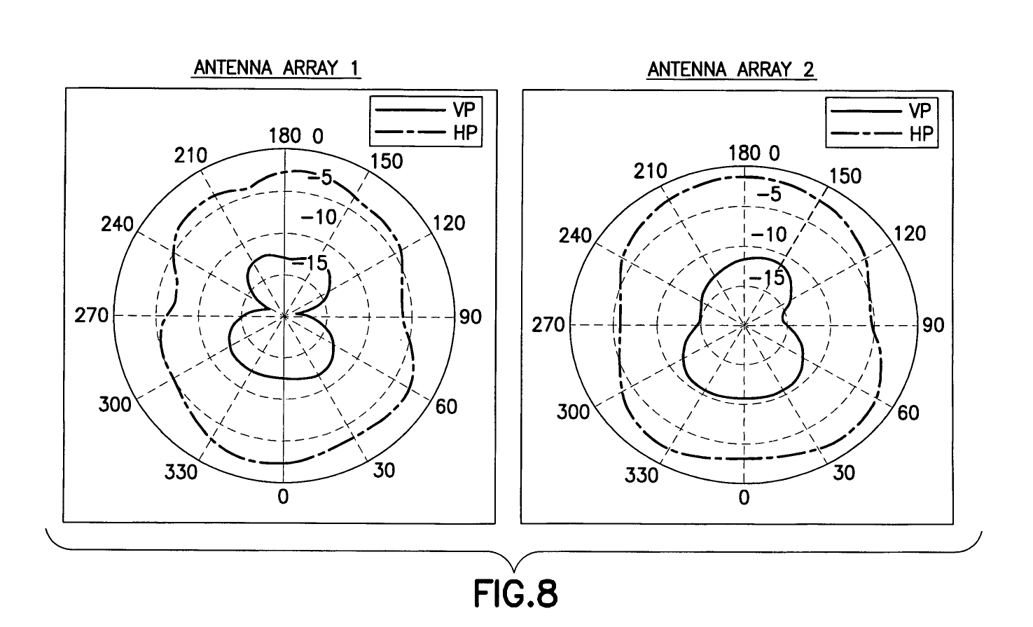

FIG. 8 displays antenna array gain graphs or 2D radiation patterns for various exemplary embodiments of this invention. These graphs show the vertical polarization (VP) and horizontal polarization (HP) component antenna gains for an antenna array which includes a left antenna, a central antenna and a right antenna. The left antenna may face in a direction 90° from the direction the central antenna is facing and the right antenna may face in a direction −90° from the direction the central antenna is facing. In the graph for antenna array 1, the left antenna is a top feeding antenna and the right antenna is a bottom feeding antenna. In the graph for antenna array 2, both the left antenna and the right antenna are top feeding antenna. The HP gains for the antenna arrays have relatively smooth pattern in all sectors and the VP is minimized.

Based on the foregoing it should be apparent that the exemplary embodiments of this invention provide a method, apparatus and computer program(s) to provide antennas suitable for direction finding systems.

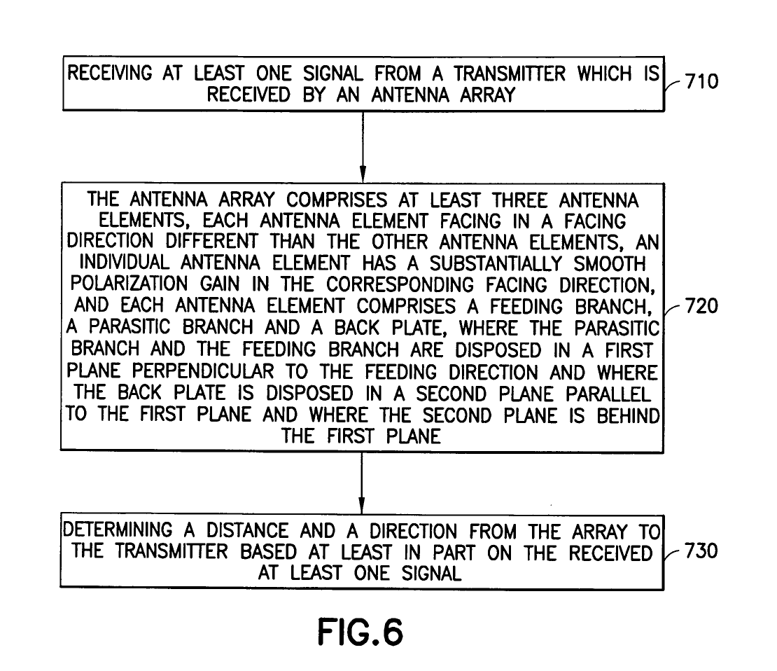

FIG. 6 is a logic flow diagram that illustrates the operation of a method, and a result of execution of computer program instructions, in accordance with the exemplary embodiments of this invention. In accordance with these exemplary embodiments a method performs, at Block 710, receiving at least one signal from a transmitter which is received by an antenna array. The antenna array comprises at least three antenna elements, each antenna element facing in a facing direction different than the other antenna elements, an individual antenna element has a substantially smooth polarization gain in the corresponding facing direction, and each antenna element comprises a feeding branch, a parasitic branch and a back plate, where the parasitic branch and the feeding branch are disposed in a first plane perpendicular to the feeding direction and where the back plate is disposed in a second plane parallel to the first plane and where the second plane is behind the first plane, as described in Block 720. At Block 730, determining a distance and a direction from the array to the transmitter is based at least in part on when the at least one signal is received.

The various blocks shown in FIG. 6 may be viewed as method steps, and/or as operations that result from operation of computer program code, and/or as a plurality of coupled logic circuit elements constructed to carry out the associated function(s). The illustration of a particular order to the blocks does not necessarily imply that there is a required or preferred order for the blocks and the order and arrangement of the block may be varied. Furthermore, it may be possible for some blocks to be omitted.

An exemplary embodiment in accordance with this invention is an apparatus for a direction finding system. The apparatus includes at least three antenna elements. Each antenna element is facing in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction and the back plate is disposed in a second plane parallel to the first plane and where the second plane is behind the first plane.

In a further exemplary embodiment of the apparatus above, each antenna element has a cross polarization ratio greater than about 10 dB.

In an additional exemplary embodiment of any one of the apparatus above, the isolation between each antenna element is greater than about 10 dB.

In a further exemplary embodiment of any one of the apparatus above, a first antenna element and a second antenna element have corresponding antenna facings in opposite directions. The first antenna element may be a top fed antenna and the second antenna element may be a bottom fed antenna. Alternatively, both the first antenna element and the second antenna element may be top fed antennas.

In an additional exemplary embodiment of any one of the apparatus above, each feeding branch and parasitic branch are disposed to form a loop structure which minimizes a vertical component of a corresponding electric field.

In a further exemplary embodiment of any one of the apparatus above, each antenna element operates in a 2.45 GHz band.

In an additional exemplary embodiment of any one of the apparatus above, at least one antenna element of the at least three antenna elements includes a serial inductor. The serial inductor may have an inductance of 1.3 nH and may be disposed in the parasitic branch.

In a further exemplary embodiment of any one of the apparatus above, the apparatus further includes an antenna frame. The at least three antenna elements are embodied in the antenna frame.

In an additional exemplary embodiment of any one of the apparatus above, the apparatus further includes a processing unit configured to perform direction finding analysis based on signals received by the at least three antenna elements.

A further exemplary embodiment in accordance with this invention is a method for direction finding. The method includes receiving at least one signal from a transmitter which is received by an antenna array. The antenna array includes at least three antenna elements, each antenna element facing in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction and the back plate is disposed in a second plane parallel to the first plane and where the second plane is behind the first plane. The method also includes determining a distance and a direction from the array to the transmitter based at least in part on the received at least one signal.

In an additional exemplary embodiment of the method above, the method also includes displaying the distance and direction. Displaying the direction may include displaying an arrow pointing in the direction.

In a further exemplary embodiment of any one of the method above, determining the distance and direction includes determining a horizontal polarization of the at least one signal.

An additional exemplary embodiment in accordance with this invention is a computer readable medium. The computer readable medium is tangibly encoded with a computer program executable by a processor to perform actions for direction finding. The actions include receiving at least one signal from a transmitter which is received by an antenna array. The antenna array includes at least three antenna elements, each antenna element facing in a facing direction different than the other antenna elements. An individual antenna element has a substantially smooth polarization gain in the corresponding facing direction. Each antenna element includes a feeding branch, a parasitic branch and a back plate. The parasitic branch and the feeding branch are disposed in a first plane perpendicular to the feeding direction and the back plate is disposed in a second plane parallel to the first plane and where the second plane is behind the first plane. The actions also include determining a distance and a direction from the array to the transmitter based at least in part on the received at least one signal.

In a further exemplary embodiment of the computer readable medium above, the actions further include displaying the distance and direction. Displaying the direction may include displaying an arrow pointing in the direction.

In an additional exemplary embodiment of any one of the media above, determining the distance and direction includes determining a horizontal polarization of the at least one signal.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (for example, εᵣ, etc.) are not intended to be limiting in any respect, as these parameters may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. An apparatus comprising:
at least three antenna elements, each antenna element facing in a facing direction different than the other antenna elements,
where an individual antenna element has a substantially smooth polarization gain in the corresponding facing direction, and
each antenna element comprises a feeding branch, a parasitic branch and a back plate, where the parasitic branch and the feeding branch are disposed in a first plane perpendicular to the feeding direction and where the back plate is disposed in a second plane parallel to the first plane and where the second plane is behind the first plane.

2. The apparatus of claim 1, where each antenna element has a cross polarization ratio greater than about 10 dB.

3. The apparatus of claim 1, where isolation between each antenna element is greater than about 10 dB.

4. The apparatus of claim 1, where a first antenna element and a second antenna element have corresponding antenna facings in opposite directions.

5. The apparatus of claim 4, where the first antenna element is a top fed antenna and the second antenna element is a bottom fed antenna.

6. The apparatus of claim 4, where the first antenna element and the second antenna element are top fed antennas.

7. The apparatus of claim 1, where each feeding branch and parasitic branch are disposed to form a loop structure which minimizes a vertical component of a corresponding electric field.

8. The apparatus of claim 1, where each antenna element operates in a 2.45 GHz band.

9. The apparatus of claim 1, where at least one antenna element of the at least three antenna elements comprises a series inductor.

10. The apparatus of claim 9, where the series inductor has an inductance of 1.3 nH and is disposed in the parasitic branch.

11. The apparatus of claim 1, where the apparatus further comprises an antenna frame, where the at least three antenna elements are embodied in the antenna frame.

12. The apparatus of claim 1, where the apparatus further comprises a processing unit configured to perform direction finding analysis based on signals received by the at least three antenna elements.

13. A method comprising:
receiving at least one signal from a transmitter which is received by an antenna array,
where the antenna array comprises at least three antenna elements, each antenna element facing in a facing direction different than the other antenna elements, an individual antenna element has a substantially smooth polarization gain in the corresponding facing direction, and each antenna element comprises a feeding branch, a parasitic branch and a back plate, where the parasitic branch and the feeding branch are disposed in a first plane perpendicular to the feeding direction and where the back plate is disposed in a second plane parallel to the first plane and where the second plane is behind the first plane; and
determining a distance and a direction from the array to the transmitter based at least in part on the received at least one signal.

14. The method of claim 13, further comprising displaying the distance and direction.

15. The method of claim 14, where displaying the direction comprises displaying an arrow pointing in the direction.

16. The method of claim 13, where determining the distance and direction comprising determining a horizontal polarization of the at least one signal.

17. A computer readable medium tangibly encoded with a computer program executable by a processor to perform actions comprising:
receiving at least one signal from a transmitter which is received by an antenna array,
where the antenna array comprises at least three antenna elements, each antenna element facing in a facing direction different than the other antenna elements, an individual antenna element has a substantially smooth polarization gain in the corresponding facing direction, and each antenna element comprises a feeding branch, a parasitic branch and a back plate, where the parasitic branch and the feeding branch are disposed in a first plane perpendicular to the feeding direction and where the back plate is disposed in a second plane parallel to the first plane and where the second plane is behind the first plane; and
determining a distance and a direction from the array to the transmitter based at least in part on the received at least one signal.

18. The computer readable medium of claim 17, where the actions further comprise displaying the distance and direction.

19. The computer readable medium of claim 18, where displaying the direction comprises displaying an arrow pointing in the direction.

20. The computer readable medium of claim 17, where determining the distance and direction comprising determining a horizontal polarization of the at least one signal.
